(19) United States
(12) Patent Application Publication
(10) Pub. No.: US 2019/0086694 A1
(43) Pub. Date: Mar. 21, 2019

(54) BIONIC SOLAR-PROTECTION DEVICE

(71) Applicant: Ford Global Technologies, LLC, Dearborn, MI (US)

(72) Inventors: Ralf Schmierer, Cologne (DE); Arnold Stadtler, Koln (DE)

(73) Assignee: Ford Global Technologies, LLC, Dearborn, MI (US)

(21) Appl. No.: 16/010,710

(22) Filed: Jun. 18, 2018

(30) Foreign Application Priority Data
Sep. 19, 2017 (DE) 102017216580.4

(51) Int. Cl. G02F 1/01

(52) U.S. Cl. CPC G02F 1/0121; B60J 7/043

(57) ABSTRACT

A solar-protection device is described for shading a light-transmitting surface, said solar-protection device including a light-transmitting component with a surface and with a number of surface elements arranged on the surface in the form of a grid, which are designed to vary their transmittance. The solar-protection device includes at least one device for determining the radiation intensity of the sunlight irradiation, at least one device for determining the direction of irradiation of the sunlight, and a control unit, designed to reduce, in a manner depending on the radiation intensity and on the direction of irradiation of the sunlight, the transmittance of a selected number of surface elements, so that the selected surface elements generate a pattern that can be varied in a manner depending on the direction of irradiation of the sunlight.

### FIELD OF THE INVENTION

The present invention generally relates to a solar-protection device for shading a light-transmitting surface, particularly for a sunroof and a vehicle, and a method for operating a solar-protection device for shading a light-transmitting surface.

### BACKGROUND OF THE INVENTION

Sunroofs, in particular sunroofs for motor vehicles, typically offer the user a defined level of shading and a transfer of heat that is defined by the configuration of the sunroof. Particularly in connection with sunroofs for passenger compartments, this may be perceived as uncomfortable by many passengers and users. For instance, there is often the conflict that it is either too warm or too bright for passengers.

U.S. Pat. No. 8,102,586 B2 discloses a window-shading system for houses and vehicles that is electronically controlled automatically, wherein the window(s) is/are partially tinted in a manner depending on the intensity of the light and on the direction of irradiation.

Against the background that has been presented, there is an interest in an improved solar-protection device that counters the aforementioned disadvantages. It is therefore desirable to make available an improved solar-protection device for shading a light-transmitting surface and a method for operating a solar-protection device that, in particular, enable a flexible consideration of the light-irradiation conditions obtained in the given case.

### SUMMARY OF THE INVENTION

According to one aspect of the present invention, a solar-protection device for shading a light-transmitting surface is provided. The solar-protection device includes a light-transmitting component with a surface, a number of surface elements arranged on the surface in the form of a grid and designed to vary transmittance, and at least one device for determining radiation intensity of sunlight irradiation. The solar-protection device also includes at least one device for determining direction of irradiation of the sunlight, and a control unit designed to reduce the transmittance of a selected number of surface elements based on the radiation intensity and the direction of irradiation of the sunlight so that the selected surface elements generate a pattern that can be varied depending on the direction of irradiation of the sunlight.

According to another aspect of the present invention, a solar-protection shading device is provided. The solar-protection shading device includes a light-transmitting component having a surface, variable transmittance elements arranged on the surface, a device determining direction of the sunlight irradiation, and a control unit controlling the transmittance of a selected number of surface elements based on the direction of the sunlight irradiation so that the selected surface elements generate a pattern that varies based on the direction of the sunlight irradiation.

According to a further aspect of the present invention, a method for operating a solar-protection device for shading a light-transmitting surface is provided. The method includes the steps of providing variable transmittance elements arranged on a surface of the light-transmitting component in the form of a grid, determining radiation intensity of the sunlight irradiation onto the surface, determining direction of the sunlight irradiation with respect to the surface, reducing the transmittance of a selected number of elements based on the radiation intensity, and selecting the elements with respect to position on the surface such that a pattern is generated and varied depending on the direction of irradiation of the sunlight.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a solar-protection device according to one embodiment in the form of a sunroof for a motor vehicle;

FIG. 2 is a perspective view of a detail of the surface of the sunroof shown in FIG. 1 and the cast shadow generated thereby;

FIG. 3 is a top view of the detail of the surface of the solar-protection device shown in FIG. 2 and the cast shadow generated thereby;

FIG. 4 is a perspective view schematic diagram of the projection of the direction of irradiation of the sunlight onto the surface of the solar-protection device; and

FIG. 5 is a side view of one example of a motor vehicle employing the solar-protection device.

### DETAILED DESCRIPTION OF THE PREFERRED EMBODIMENTS

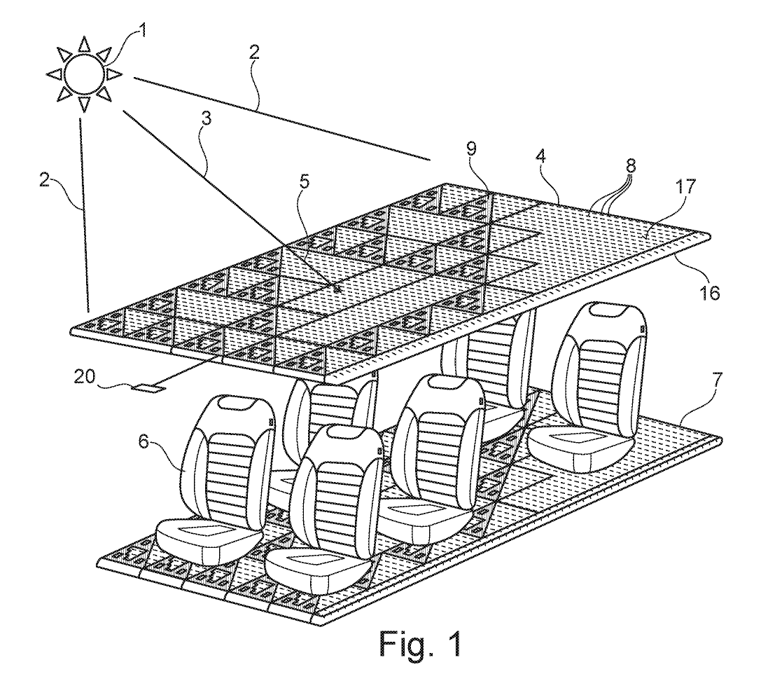

FIG. 1 shows a solar-protection device 4 schematically, according to one embodiment. The device 4 is configured in the present practical variant as a sunroof for a vehicle. The solar-protection device 4 can be used equally for window-panes, glass roofs, glass walls, or fundamentally light-transmitting windows, doors, walls or other components. In the case of an application in connection with a vehicle, the vehicle may be, for instance, an aircraft, a ship or a motor vehicle 15, for instance a passenger car, a truck, a motorcycle or another motor vehicle.

In the embodiment shown in FIG. 1, seats 6 of a motor vehicle located in a passenger compartment are indicated in exemplary manner, above which a roof, not shown explicitly, with a light-transmitting surface is arranged. The vehicle roof includes a skylight and is configured with a solar-protection device 4 according to one embodiment.

The solar-protection device 4 includes a light-transmitting component 16 with a surface 17 and with a number of surface elements 8 arranged on the surface 17 in the form of a grid. The surface elements 8 are designed to vary their transmittance, in particular their transmittance in respect of visible light. In the example shown, the transmittance for the surface element labeled by way of example by reference numeral 9 has been lowered. In this example, the surface element 9 has accordingly been tinted. By virtue of the surface elements 8 and 9 that have been partially tinted or, to be more exact, that have had their transmittance lowered, a cast shadow is generated on the vehicle seats 6, that is to say, for instance, in the passenger compartment. The cast shadow is labeled by reference numeral 7.

The device 4 according to one embodiment further includes at least one device for determining the radiation intensity of the sunlight irradiation 2. In FIG. 1 the sun is labeled schematically by reference numeral 1. The radiation emanating from the sun 1 is indicated schematically by a cone of light 2. The direction of irradiation of the sunlight 2 onto the surface 17 is labeled by an arrow with reference numeral 3. The projection of the direction of irradiation 3 onto the surface 17 is labeled by an arrow with reference numeral 5.

The solar-protection device 4 includes, in addition, at least one device 20 for determining the direction of irradiation 3 of the sunlight. The device 20 for determining the radiation intensity and the device for determining the direction of irradiation of the sunlight may each include one or more sensors such as light sensor. The radiation intensity and the direction of irradiation may, for example, also be determined by use of a single device. In principle, the at least one device 20 may be arranged on or against the roof of a motor vehicle or may be designed for arrangement on or against the roof of a motor vehicle.

The solar-protection device 4 according to one embodiment includes, in addition, a control unit 10 which is shown in FIG. 3. The control unit 10 is designed to reduce, in a manner depending on the radiation intensity and on the direction of irradiation 3 of the sunlight, the transmittance of a selected number of surface elements 8 and 9, so that the selected surface elements 9 form or generate a pattern that can be varied in a manner depending on the direction of irradiation 3 of the sunlight.

In the variant shown in FIG. 1, a pattern is formed by the surface elements labeled by reference numeral 9. The pattern that is shown comprises a plurality of triangular structures. The pattern is configured in the form of a Sierpinski triangle. The pattern accordingly comprises fractals and represents a schematic imitation of the cast shadow of a tree.

In principle, it is advantageous if the density of the selected surface elements 9 decreases in the direction of the projection 5 onto the surface 17, which corresponds to a projection of the solar irradiation 3. As a result, it is guaranteed that the region of the surface 17 that is most affected by the solar irradiation is dimmed most intensely.

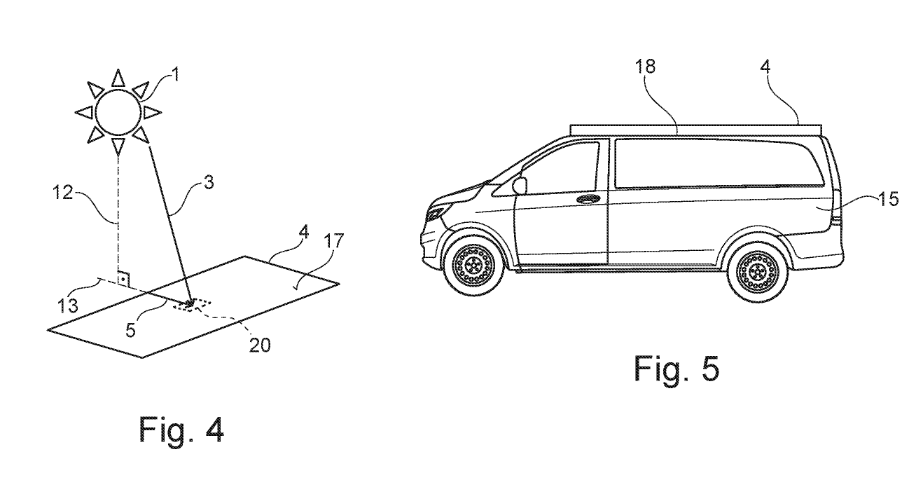

The formation of the projection direction 5 or the ascertainment thereof is shown schematically in FIG. 4. In the example shown therein, starting from a perpendicular or a vertical line 12 from the sun 1 in the direction toward the earth, from the direction of irradiation 3 and from a the direction of irradiation 3 in a horizontal line 13 along the surface 17, a right-angled triangle is formed. In this case, the direction of the horizontal line 13 on the surface 17 specifies the projection direction 5.

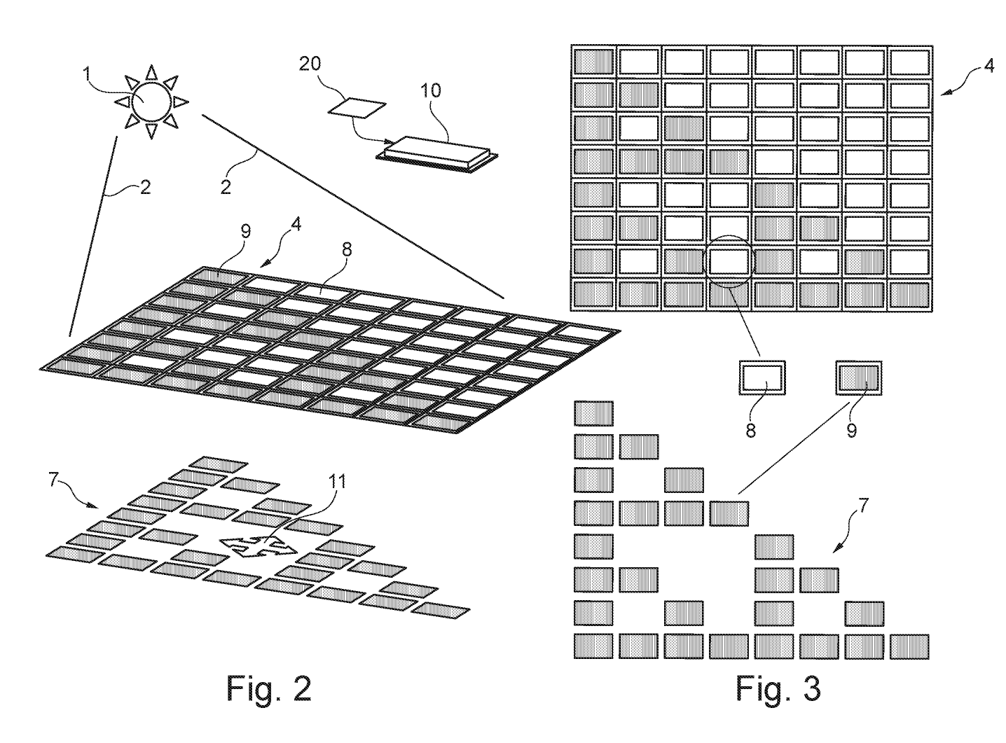

In FIG. 2, a detail of the surface 17 of the device 4 according to one embodiment is represented on an enlarged scale in perspective view. Moreover, the cast shadow 7 generated thereby is represented schematically underneath. The variation of the cast shadow 7 or the variation of the generated pattern is labeled by arrows 11. The shadow patterns are preferentially varied on the basis of the position of the sun 1 or in a manner depending on the direction of irradiation 3 and its projection 5 onto the surface 17. The selected surface elements 9, which have had their transmittance lowered, may for example be displaced by a defined number of surface elements in a defined direction 11 on the surface 17 in the event of a variation of the angle of the direction of irradiation 3 or its projection 5. In other words, the selection of the position of the surface elements 9, the transmittance of which is being lowered, is varied.

FIG. 3 shows schematically a detail of the solar-protection device 4 according to one embodiment in a top view. In the lower part of FIG. 3 the cast shadow 7 generated by the detail shown in the upper part is shown in a top view. The darkly shaded surface elements 9 represent those surface elements, the transmittance of which was reduced. The brightly represented surface elements 8 label the surface elements that are unchanged in their transmittance, that is to say, for example, the completely transparent surface elements. All the surface elements 8 and 9 are connected to a control unit 10, for instance an electronic control unit (ECU), and can be controlled, for instance regulated, by the unit.

The control unit 10 is designed to reduce, in a manner depending on the radiation intensity and on the direction of irradiation 3 of the sunlight 2, the transmittance of a selected number of surface elements 9, so that the selected surface elements 9 generate a pattern. In this connection, the generated pattern can be varied in a manner depending on the direction of irradiation 3 of the sunlight 2 or the projection 5 thereof onto the surface 17.

Within the scope of the method for operating a solar-protection device according to one embodiment, for instance a sunroof shown in FIGS. 1 and 5, the radiation intensity of the solar irradiation onto the surface 17 is determined. The direction of the solar irradiation 5 with respect to the surface 17 is determined. If the radiation intensity exceeds a threshold value, the transmittance of a number of surface elements 9 is reduced. These elements are accordingly dimmed. In this case, the number of selected surface elements is defined in a manner depending on the radiation intensity, and the surface elements are selected with respect to their position on the surface 17 in such a way that a pattern is generated. The pattern is varied in a manner depending on the direction of irradiation 3 of the sunlight or the projection 5 thereof. A pattern already described above on the basis of FIGS. 1-3, comprising triangular structures, is preferably generated.

The surface elements 8 and 9 may include glass. Moreover, a number of or all of the surface elements may include material comprising electrochromatic material and/or thermochromatic material and/or micro-blinds and/or nanocrystalline material and/or PDLC material and/or liquid-crystal material. In one specific embodiment, the surface 17 may be coated with an LCD film, for example with an electrochromatic LCD film.

FIG. 5 shows schematically a motor vehicle 15 according to one embodiment. The vehicle includes a roof 18 and a solar-protection device 4 such as is shown in FIGS. 1-4 configured as a sunroof

The solar-protection device 4, according to one embodiment, for shading a light-transmitting surface includes a light-transmitting component with a surface and with a number of surface elements arranged on the surface in the form of a grid. The surface elements are designed to vary their transmittance, in particular their transmittance in respect of visible light. The solar-protection device includes at least one device, for example a sensor, for determining the radiation intensity of the sunlight irradiation, for instance the luminous intensity, at least one device for determining the direction of irradiation of the sunlight, and a control unit. The control unit is designed to reduce, in a manner depending on the radiation intensity and on the direction of irradiation of the sunlight, the transmittance of a selected number of surface elements, so that the selected surface elements form or generate a pattern. The control unit is, in particular, designed to select the surface elements, the transmittance of which is being reduced, in such a way that these elements form or generate a pattern comprising a plurality of triangular structures. The pattern can be varied in a manner depending on the direction of irradiation of the sunlight.

The solar-protection device 4, according to this embodiment, has the advantage that a variation of the generated pattern and of the shaded surface is made possible and hence the extent of the shading. For example, the intensity of the shading and the shape of the shading can be adapted to the cast shadow of shade-providers occurring in nature, for example to the cast shadow of trees. In this way, a shading can be obtained that is very organic and perceived as pleasant by a user. In this case, the problem, described above, of a shading that is either too intense or too slight, and of a correspondingly too intense or too slight evolution of heat is countered at the same time.

The surface elements arranged in the form of a grid may have been arranged side by side in one plane. They may have been connected to one another. The surface elements may have been configured as pixel elements or mosaic elements. The control unit is preferably configured as an electronic control unit (ECU).

In a preferred configuration, the control unit is designed to reduce, in a manner depending on the radiation intensity, for example, the luminous intensity and on the direction of irradiation of the sunlight, the transmittance of a selected number of surface elements, so that the selected surface elements form or generate a pattern comprising a plurality of triangular structures. The control unit is, in particular, designed to select the surface elements, the transmittance of which is being reduced, in such a way that these elements form or generate a pattern comprising a plurality of triangular structures.

The generation of a pattern comprising triangular structures, in particular a pattern formed from triangular structures, has the advantage that it is particularly well suited for the imitation of cast shadows generated by trees or shrubs. This means that a shading can be realized that is oriented toward cast shadows occurring in nature. The dynamic adaptation realized or the possibility of such an adaptation, of the shape and design of the pattern to the direction of irradiation of the sunlight reflects the variations, occurring in nature, of the direction and size of cast shadows.

The control unit 10 is preferably designed to reduce the density of the selected surface elements in the direction of the projection of the solar irradiation onto the surface. In other words, the regions of the surface facing toward the sun are darkened more intensely. This too is oriented toward the natural cast shadow of plants or objects in nature, where likewise the most intense darkening is to be observed at positions at which the shade-providing object is arranged geometrically between the sun and the observer.

In a particularly advantageous configuration, the control unit 10 is designed to select the surface elements in such a way that these elements generate a pattern that imitates the cast shadow of a tree. This has the advantage that the user feels himself/herself to be in a natural environment, and as a rule this is perceived by him/her as pleasant. In addition, by virtue of the design of the cast shadow that is oriented toward nature, at the same time it is guaranteed that a harmonious relationship is obtained between a sufficient shading, or darkening, and the evolution of heat that is associated with a darkening.

In a further variant, the control unit 10 may be designed to select the surface elements in such a way that these elements generate a pattern comprising fractals. In particular, the control unit may be designed to select the surface elements in such a way that these elements generate a pattern in the form of a Sierpinski triangle. The use of fractals or structures comprising fractals, in particular the use of Sierpinski triangles, has the advantage that patterns of such a type are mathematically comparatively easy to translate into practical reality and at the same time reflect natural events and development processes. For example, the cast shadow of a tree can be imitated in straightforward manner with the aid of fractals, for example with the aid of one or more Sierpinski triangles.

A number of surface elements, for instance all the surface elements that are being used, may include material comprising glass and/or electrochromatic material and/or thermochromatic material and/or micro-blinds—that is to say, switchable glass—and/or nanocrystalline material and/or PDLC material, in particular PDLC glass (PDLC—polymer-dispersed liquid crystal) and/or liquid-crystal material. In particular, the surface of the device may have been coated with a LCD film (LCD—liquid-crystal display). With the aid of the stated materials, the switchability of the surface elements with respect to their transmittance can be translated into practical reality in exemplary manner.

The sunroof according to one embodiment, which, in particular, may have been designed for a vehicle, includes a previously described device. The vehicle according to this embodiment includes a previously described device and/or a sunroof. In an exemplary variant, the vehicle may include a number of window-panes or mirrors that are equipped with a device described above.

The sunroof according to one embodiment and the vehicle fundamentally have the same features and properties, as well as advantages, as the solar-protection device 4 described above. The vehicle 15 may be a motor vehicle, in particular a passenger car, a truck, a motorcycle, but it may also be a ship or an aircraft. In the case of ships or aircraft, the control unit 10 may be designed to select the surface elements in such a way that these elements generate a pattern that imitates the cast shadow of at least one cloud.

The method according to one embodiment for operating a solar-protection device 4 for shading a light-transmitting surface relates to a solar-protection device which includes a light-transmitting component with a surface and with a number of surface elements arranged on the surface in the form of a grid. In this connection, the surface elements are designed to vary their transmittance, in particular to vary their transmittance in respect of visible light. The surface elements may have been arranged side by side in one plane. The surface elements may have been connected to one another. Within the scope of the method, the radiation intensity, in particular the luminous intensity, of the sunlight irradiation onto the surface is determined. Moreover, the direction of the sunlight irradiation with respect to the surface is determined. If the radiation intensity, in particular the luminous intensity, exceeds a threshold value, the transmittance of a number of surface elements is reduced. In this case, the number of surface elements is defined in a manner depending on the radiation intensity, and the surface elements are selected with respect to their position on the surface in such a way that a pattern is generated. The pattern is varied in a manner depending on the direction of irradiation of the sunlight.

The method according to this embodiment is suited, in particular, for the use of a solar-protection device 4 described above. The method fundamentally has the advantages already described above. In particular, by virtue of the variation of the generated pattern in a manner depending on the direction of irradiation of the sunlight, a cast shadow can be generated that is perceived to be natural. In this case, the cast shadow can preferably imitate cast shadows, occurring in nature, of plants, for instance, trees or clouds.

The surface elements are preferably selected with respect to their position on the surface in such a way that a pattern comprising a plurality of triangular structures is generated. In an advantageous variant, the surface elements are selected in such a way that the density of the selected surface elements decreases in the direction of the projection of the direction of the solar irradiation onto the surface. The surface elements can fundamentally be selected in such a way that they generate a pattern that imitates the cast shadow of a tree. This is perceived by users as particularly pleasant, and at the same time has the advantage that a harmonious relationship of shading and evolution of heat caused by the shading can be created.

The surface elements are preferably selected in such a way that a pattern comprising fractals is generated. For example, the surface elements can be selected in such a way that these elements generate a pattern in the form of at least one Sierpinski triangle.

In principle, the patterns described above, in particular a pattern that imitates the cast shadow of a tree, or a pattern comprising fractals, can, on the one hand, be generated by the surface elements, the transmittance of which was reduced—that is to say, which were tinted. But it is also possible to generate an appropriate pattern by use of the surface elements that were not tinted, that is to say, having a transmittance that was not reduced. In this way, the cast shadow of a tree, for instance, can be imitated as a negative.

In principle, the surface elements that are used within the scope of the method may comprise the materials stated above in connection with the solar-protection device 4 according to the embodiment disclosed. In particular, the surface of the solar-protection device 4 may have been coated with an LCD film (LCD—liquid-crystal display).

The present solar-protection device 4 offers a configuration, inspired from nature, of a solar-protection device which, for instance, imitates the shadow pattern similar to the cast shadow of a tree. The orientation toward cast shadows, occurring in nature, of natural shade-providers lessens the disadvantages, described above, of the shading devices known hitherto for transparent surfaces, in particular for vehicle windows and vehicle roofs.

The size and the geometrical configuration of the shadow pattern generated within the scope of the invention may in this case be adapted in such a way that the generated pattern exhibits the most favorable form for the user with respect to the generated cast shadow. In this way, a particularly favorable mixture of darkening, for example tinting, of transparent surfaces and of the associated generation of heat can be obtained. The distribution of light that is observed in nature underneath a tree represents an example that is worthy of imitation, since here a combination of optimal temperature and, at the same time, sufficient light exposure which, in particular, enables plant growth, has been realized in natural manner in natural form.

Further features, properties and advantages of the present invention are described herein in more detail on the basis of an embodiment with reference to the appended figures. All the features described hitherto and in the following are advantageous in this connection, both individually and in an arbitrary combination with one another. The embodiment described herein represents merely one example which, however, does not restrict the subject-matter of the invention.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A solar-protection device for shading a light-transmitting surface, comprising:
a light-transmitting component with a surface;
a number of surface elements arranged on the surface in the form of a grid and designed to vary transmittance;
at least one device for determining radiation intensity of sunlight irradiation;
at least one device for determining direction of irradiation of the sunlight; and
a control unit designed to reduce the transmittance of a selected number of surface elements based on the radiation intensity and the direction of irradiation of the sunlight so that the selected surface elements generate a pattern that can be varied depending on the direction of irradiation of the sunlight.

2. The solar-protection device as claimed in claim 1, wherein the control unit is designed to reduce the transmittance of a selected number of surface elements based on the radiation intensity and on the direction of irradiation of the sunlight, so that the selected surface elements generate a pattern comprising a plurality of triangular structures.

3. The solar-protection device as claimed in claim 1, wherein the control unit is designed to decrease the density of the selected surface elements in the direction of the projection of the direction from which the solar irradiation is coming onto the surface.

4. The solar-protection device as claimed in claim 1, wherein the control unit is designed to select the surface elements to generate a pattern that imitates the cast shadow of a tree.

5. The solar-protection device as claimed in claim 1, wherein the control unit is designed to select the surface elements to generate a pattern comprising fractals.

6. The solar-protection device as claimed in claim 1, wherein the control unit is designed to select the surface elements to generate a pattern in the form of a Sierpinski triangle.

7. The solar-protection device as claimed in claim 1, wherein the number of surface elements include glass and/or material comprising electrochromatic material and/or thermochromatic material and/or micro-blinds, and/or nanocrystalline material and/or PDLC material and/or liquid-crystal material.

8. The solar-protection device of claim 1, wherein the solar-protection device is provided in a sunroof

9. The solar-protection device of claim 1, wherein the solar-protection device is provided in a vehicle.

10. A solar-protection shading device comprising:
a light-transmitting component having a surface;
variable transmittance elements arranged on the surface;
a device determining direction of the sunlight irradiation; and
a control unit controlling the transmittance of a selected number of surface elements based on the direction of the sunlight irradiation so that the selected surface elements generate a pattern that varies based on the direction of the sunlight irradiation.

11. The solar-protection shading device as claimed in claim 10 further comprising a device determining intensity of sunlight irradiation, wherein the control unit controls the transmittance of the selected number of surface elements further based on the intensity.

12. The solar-protection shading device as claimed in claim 11, wherein the control unit is designed to reduce the transmittance of a selected number of surface elements based on the radiation intensity and on the direction of irradiation of the sunlight so that the selected surface elements generate a pattern comprising a plurality of triangular structures.

13. The solar-protection shading device as claimed in claim 10, wherein the control unit is designed to decrease density of the selected surface elements in the direction of the projection of the direction from which the solar irradiation is coming onto the surface.

14. The solar-protection shading device as claimed in claim 10, wherein the control unit is designed to select the surface elements to generate a pattern that imitates the cast shadow of a tree.

15. The solar-protection shading device as claimed in claim 10, wherein the control unit is designed to select the surface elements to generate a pattern comprising fractals.

16. The solar-protection shading device as claimed in claim 10, wherein the control unit is designed to select the surface elements to generate a pattern in the form of a Sierpinski triangle.

17. The solar-protection shading device as claimed in claim 10, wherein the number of surface elements include glass and/or material comprising electrochromatic material and/or thermochromatic material and/or micro-blinds, and/or nanocrystalline material and/or PDLC material and/or liquid-crystal material.

18. The solar-protection shading device of claim 10, wherein the solar-protection device is provided in a sunroof of a vehicle.

19. A method for operating a solar-protection device for shading a light-transmitting surface, comprising:
providing variable transmittance elements arranged on a surface of the light-transmitting component in the form of a grid;
determining radiation intensity of the sunlight irradiation onto the surface;
determining direction of the sunlight irradiation with respect to the surface;
reducing the transmittance of a selected number of elements based on the radiation intensity; and
selecting the elements with respect to position on the surface such that a pattern is generated and varied depending on the direction of irradiation of the sunlight.

20. The solar-protection device as claimed in claim 19, wherein the transmittance is reduced when the radiation exceeds a threshold value.
